(19) United States
(12) Patent Application Publication
(10) Pub. No.: US 2016/0105103 A1
(43) Pub. Date: Apr. 14, 2016

(54) SWITCHING CONTROLLING CIRCUIT, CONVERTER USING THE SAME, AND SWITCHING CONTROLLING METHOD

(71) Applicant: SOLUM CO., LTD., SUWON-SI (KR)

(72) Inventors: Bo Hyun HWANG, Suwon-Si (KR); Jin Soo LEE, Suwon-Si (KR); Seung Kon KONG, Suwon-Si (KR); Dae Hoon HAN, Suwon-Si (KR)

(73) Assignee: SOLUM CO., LTD., SUWON-SI (KR)

(21) Appl. No.: 14/813,798

(22) Filed: Jul. 30, 2015

(30) Foreign Application Priority Data
Oct. 8, 2014 (KR) 10-2014-0136099

(51) Int. Cl. H02M 3/156

(52) U.S. Cl. CPC H02M 3/156

(57) ABSTRACT

The converter includes: a switching unit; an energy storing unit storing energy from direct current input power and then generating an output voltage according to a switching operation of the switching unit; and a switching controlling unit turning on the switching unit when a voltage between one end of the switching unit and the other end thereof reaches a zero point of a resonance waveform, wherein the switching controlling unit includes: a voltage detecting unit detecting the voltage one end of the switching unit and the other end thereof in case of a resonance waveform; a first comparator comparing the voltage detected by the voltage detecting unit with a predetermined first reference voltage corresponding to the zero point of the resonance waveform and outputting a first signal according to a comparison result; and a switching driving unit turning on the switching unit in response to the first signal.

This application claims the foreign priority benefit under 35 U.S.C. Section [120, 119, 119(e)] of Korean Patent Application Serial No. 10-2014-0136099 entitled “Switching Controlling Circuit, Converter Using the Same, and Switching Controlling Method” filed on Oct. 8, 2014, which is hereby incorporated by reference in its entirety into this application.

### BACKGROUND OF THE INVENTION

1. Technical Field

Embodiments of the present invention relates to a switching controlling circuit, a converter using the same, and a switching controlling method.

2. Description of the Related Art

In electronic communication devices, miniaturization and lightness of a system portion has been rapidly implemented in accordance with a development of a semiconductor integrated circuit, while miniaturization and lightness of a source portion has not been implemented as expected due to energy storage elements such as inductor, capacitor, and the like.

Therefore, in order to accord with a recent trend of miniaturization and lightness of the electronic communication devices, miniaturization and lightness of a converter used for a power apparatus, particularly, a switching mode power supply (SMPS), or the like form a very importance part.

In the converter used for the SMPS, or the like, since the more a switching frequency increases, the more decreased capacity of the energy storage element is, miniaturization and lightness of the converter may be implemented by a high speed switching.

However, in the case in which the switching frequency is increased by using a high speed semiconductor switching element, or the like, problems such as switch loss, heating of the switching element, and the like may occur, and due to an influence of accumulated charges possessed by inductance, capacitance, a diode, or the like in a circuit, surge, noise, and the like occur, and consequently, reliability of the SMPS itself is also degraded.

### SUMMARY OF THE INVENTION

An aspect of the present invention is to provide a switching controlling circuit capable of performing a soft switching by using a simple circuit configuration, a converter using the same, and a switching controlling method.

According to an exemplary embodiment of the present disclosure, there are provided a switching controlling circuit turning on a switching element when a voltage between both ends of the switching element reaches a zero point of a resonance waveform, a converter using the same, and a switching controlling method.

According to another exemplary embodiment of the present disclosure, there are provided a switching controlling circuit turning on a switching element by only a configuration of a comparator, or the like, a converter using the same, and a switching controlling method.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a drawing schematically showing current and voltage waveforms of a switching element according to a switching mode;

FIG. 2 is a schematic circuit diagram of a converter which is generally used at present;

FIG. 3 is a graph showing an operation waveform of the converter of FIG. 2 depending on input and output conditions;

FIG. 4 is a drawing for describing switching loss in a hard-switching mode;

FIG. 5 is a schematic circuit diagram of a converter according to an exemplary embodiment of the present invention;

FIG. 6 is a graph showing signal waveforms for main components of the converter of FIG. 5; and

FIGS. 7A and 7B are graphs showing operation waveforms of the converter of FIG. 5 depending on direct current input power conditions.

### DESCRIPTION OF EMBODIMENTS

The acting effects and technical configuration with respect to the objects of a switching controlling circuit, a converter using the same, and a switching controlling method according to the present invention will be clearly understood by the following description in which exemplary embodiments of the present invention are described with reference to the accompanying drawings.

Further, when it is determined that the detailed description of the known art related to the present invention may obscure the gist of the present invention, the detailed description thereof will be omitted. Additionally, components shown in the accompanying drawings are not necessarily shown to scale. For example, sizes of some components shown in the accompanying drawings may be exaggerated as compared with other components in order to assist in understanding of exemplary embodiments of the present invention. Like reference numerals on different drawings will denote like components, and similar reference numerals on different drawings will denote similar components, but are not necessarily limited thereto.

In the description, the terms “first”, “second”, and so on are used to distinguish one element from another element, and the elements are not defined by the above terms.

Necessity of Soft-Switching

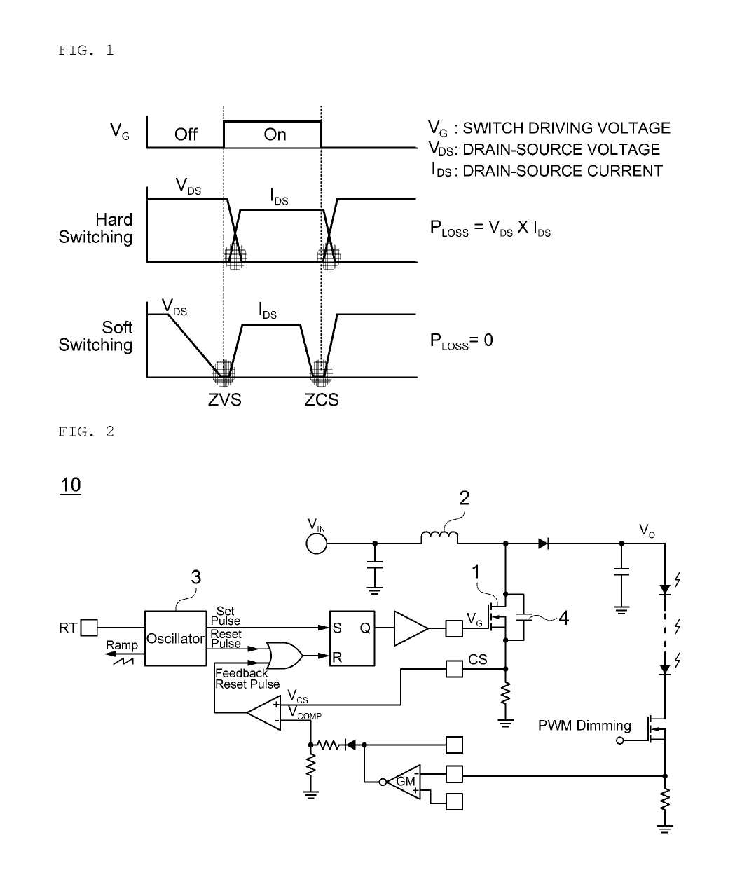

FIG. 1 schematically shows current and voltage waveforms of a switching element according to a switching mode.

As shown in FIG. 1, in case of a hard-switching mode, switch loss P_{LOSS} (portion in which a drain-source voltage V_{DS} and a drain-source current I_{DS} are overlapped) occurs at the time of switching of a switching element.

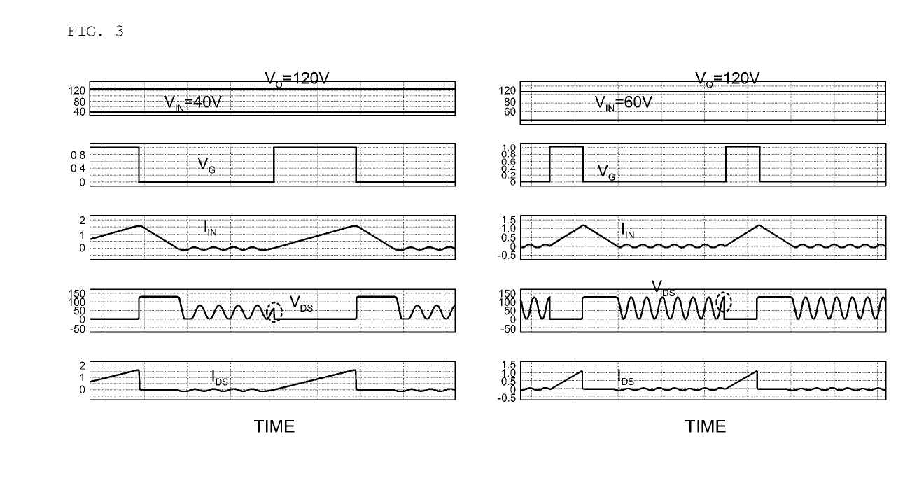

The above-mentioned switching loss also occurs in a converter which is generally used for an SMPS at present and a description thereof will be provided below with reference to FIGS. 2 and 3.

First, FIG. 2 is a schematic circuit diagram of a converter 10 which is generally used at present and FIG. 3 is a graph showing an operation waveform of the converter 10 of FIG. 2 depending on input and output conditions.

Referring to FIGS. 2 and 3, when a switching element 1 is turned on (V_{G} is converted into a high level), an inductor current I_{IN} is increased and an inductor 2 stores energy. In addition, when the switching element 1 is turned off (V_{G} is converted into a low level), the energy stored in the inductor 2 is transferred as an output voltage Vo of a converter 10.

Then, once the current of the inductor 2 is perfectly discharged, the current I_{DS} flowing in the switching element 1 performs resonance that fluctuation in a positive (+) direction and a negative (−) direction is continuously repeated, by the inductor 2 and a parasitic capacitor (not shown) of the switching element 1 or the inductor 2 and a snubber capacitor 4, and as a result, the voltage Vas across the switching element 1 also performs the resonance at the same frequency as the I_{DS} in the switching element 1.

In this case, a hard-switching in which the switching element 1 is turned on at an arbitrary voltage level (see a broken line of FIG. 3) at which a resonance waveform of the voltage Vas across the switching element 1 is not zero, as shown in FIG. 3 occurs in the converter 10 of FIG. 2. As a result, problems such as switching loss, heating of the switching element, and the like occur.

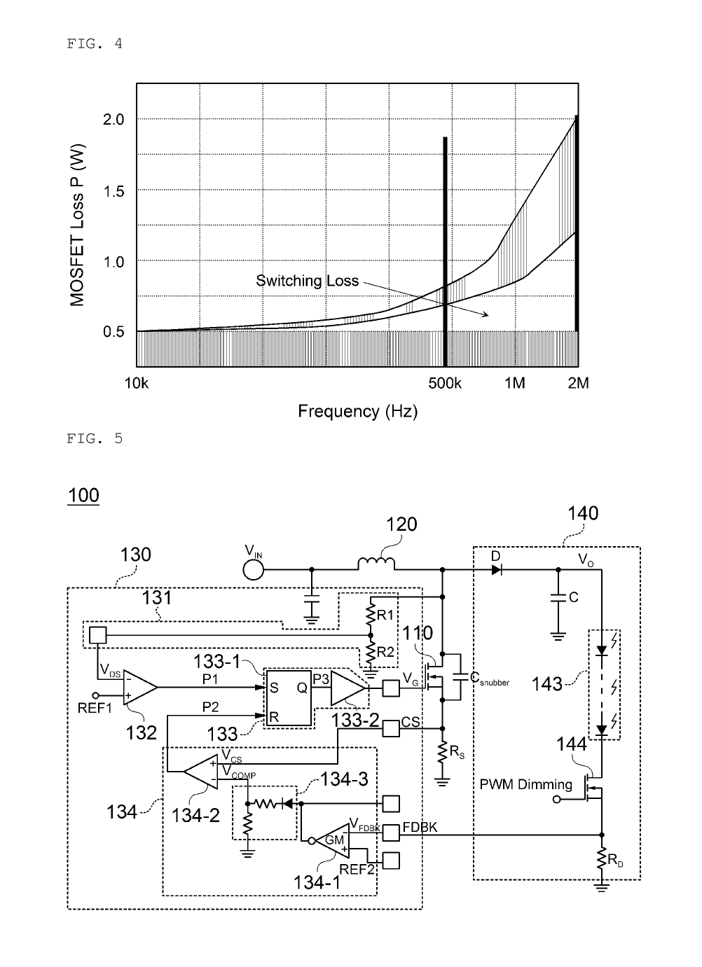

The switching loss in the above-mentioned hard-switching mode will be described in more detail in FIG. 4. As shown in FIG. 4, in the case of the hard-switching mode, it may be appreciated that the switching loss at a switching frequency of MHz or more is increased in proportion to the frequency.

Therefore, in order to reduce the switching loss due to a high speed switching, a driving of a so-called soft-switching mode of switching the switching element so that the switch loss P_{LOSS} becomes zero (also including a range that substantially closes to zero), as shown in FIG. 1 is required.

That is, for example, a switching driving mode is required in which a zero voltage switching (ZVS) operation in which the drain-source voltage V_{DS} becomes zero is performed when the switching element is turned on, and a zero current switching (ZCS) operation in which the drain-source current I_{DS} becomes zero is performed, as shown in FIG. 1.

Therefore, the present exemplary embodiment adopts the zero voltage switching mode enabling the soft-switching by turning on the switching element when the voltage across the switching element reaches a zero point in the resonance waveform and adopts an example of a switching controlling configuration enabling the above-mentioned zero voltage switching by only a simple circuit configuration. Hereinafter, a detailed description thereof will be provided.

### EXEMPLARY EMBODIMENT OF THE PRESENT INVENTION

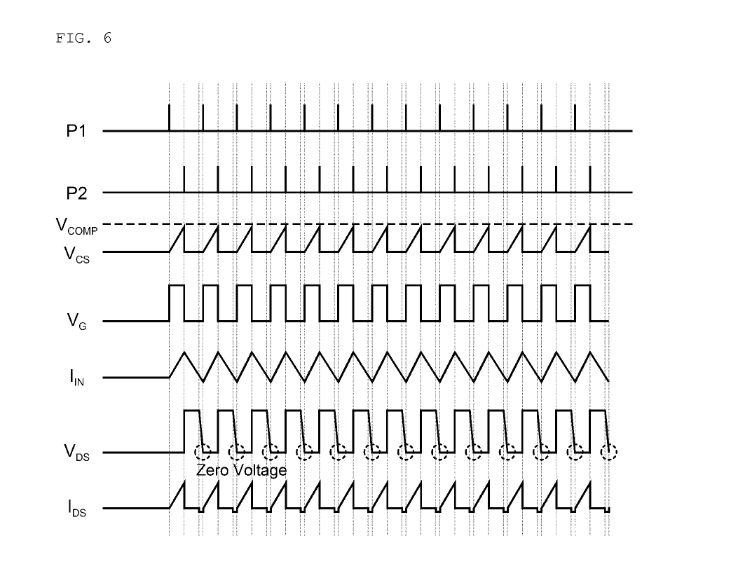

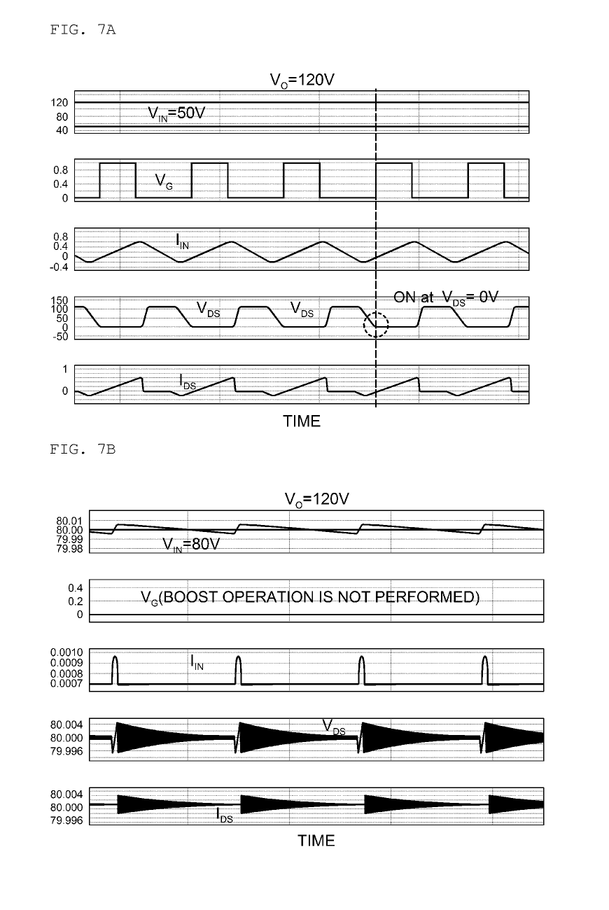

FIG. 5 is a schematic circuit diagram of a converter 100 according to an exemplary embodiment of the present invention, FIG. 6 is a graph showing signal waveforms for main components of the converter 100 of FIG. 5, and FIGS. 7A and 7B are graphs showing operation waveforms of the converter 100 of FIG. 5 depending on direct current input power V_{IN} conditions.

Although the present exemplary embodiment describes the case in which the converter 100 is implemented as a boost converter, the present invention is not limited thereto. In addition, although the case in which the converter 100 according to the present exemplary embodiment supplies power to an LED string 143 having a plurality of LED elements connected in series with each other, the present invention is not limited thereto.

The converter 100 according to the present exemplary embodiment may include a switching unit 110, an energy storing unit 120, a switching controlling unit 130, and an outputting unit 140, as shown in FIG. 5.

In addition, although not shown in the drawings, the converter 100 according to the present exemplary embodiment may include a power supplying unit rectifying input power so as to generate direct current input power V_{IN}, wherein the power supplying unit may include a bride diode, a line filter, and the like.

In this case, the bride diode may be configured by four diodes and perform a full-wave rectification for alternating current input power so as to generate the direct current input power V_{IN} in FIG. 5.

In addition, the line filter may include two capacitors connected in parallel to both terminals to which alternating current power is input and two inductors connected in series with both terminals to which the alternating current power is input.

In this case, the line filter filters electromagnetic wave interference of the alternating current input power.

Meanwhile, the switching unit 110 according to the present exemplary embodiment may be implemented as a FET switching element, but the present invention is not limited thereto. For example, as long as it may perform a switching operation, any switching element may also be adopted.

The switching unit 110 according to the present exemplary embodiment may have a parasitic capacitor formed between a drain electrode and a source electrode and may have a snubber capacitor connected in parallel thereto, as shown in FIG. 5.

Hereinafter, a voltage across the switching unit 110 is referred to as a “drain voltage V_{DS}” and a current flowing in the switching unit 110 is referred to as a “drain current I_{DS}”.

In addition, the energy storing unit 120 according to the present exemplary embodiment may be generally implemented as an inductor, and have one end to which the direct current input power V_{IN} is supplied and the other end connected to an anode electrode of an output diode D and one end (drain electrode) of the switching unit 110.

The direct current input power V_{IN} is transferred to the energy storing unit 120. In this case, the energy storing unit 120 stores a current (hereinafter, referred to as an “energy storing unit current I_{IN}) flowing into the energy storing unit 120 by the direct current input power V_{IN} and then generates the output voltage V_{O} by using the energy storing unit current I_{IN}.

The above-mentioned energy storage and output voltage V_{O} generation of the energy storing unit 120 are controlled according to a switching operation of the switching unit 110.

That is, referring to FIGS. 5 and 6, during a period in which the switching unit 110 is turned on (in the present exemplary embodiment, a section in which V_{G} of FIG. 6 is at the high level), the energy storing unit current I_{IN} is increased and the energy storing unit 120 stores energy. In addition, during a period in which the switching unit 110 is turned off (in the present exemplary embodiment, a section in which V_{G} of FIG. 6 is at the low level), the energy storing unit current I_{IN} flows through the output diode D and the energy stored in the energy storing unit 120 is transferred to the outputting unit 140, thereby generating the output voltage V_{O}.

Meanwhile, once the switching unit 110 is turned on and the output diode D is conducted, the energy storing unit current I_{IN} flows into a load 143 (in the present exemplary embodiment, the LED string) of the output unit 140 and consequently, charges the output capacitor C.

In this case, as the load is increased, the energy storing unit current I_{IN} supplied to the load 143 is increased. Therefore, the current flowing into the output capacitor C is relatively decreased, and consequently, the output voltage V_{O} is relatively decreased.

On the contrary, as the load is decreased, the energy storing unit current I_{IN} supplied to the load 143 is decreased. Therefore, the current flowing into the output capacitor C is relatively increased, and consequently, the output voltage V_{O} is relatively increased.

The output voltage V_{O} may be constantly maintained irrespective of variation in the load by the above-mentioned operations.

In addition, if the energy of the energy storing unit 120 is fully supplied to the load 143, the output diode D is interrupted. In this case, due to a resonance between the energy storing unit 120 and the parasitic capacitor of the switching unit 110 or the energy storing unit 120 and the snubber capacitor C_{snubber}, the drain voltage V_{DS} of the switching unit 110 is decreased as shown in FIG. 6.

In addition, during the period in which the switching unit 110 is turned off, due to a resonance between the energy storing unit 120 and the parasitic capacitor or the energy storing unit 120 and the snubber capacitor C_{snubber}, a period in which the energy storing unit current I_{IN} flows backwardly occurs, as shown in FIG. 6.

In addition, referring to FIGS. 5 and 6, the drain voltage V_{DS} is decreased and the switching unit 110 is then turned on, so that the energy storing unit current I_{IN} flows through the switching unit 110. In this case, as shown in FIG. 6, during the period in which the switching unit 110 is turned on, the drain current I_{DS} is the same as the energy storing unit current I_{IN}.

Meanwhile, the converter 100 according to the present exemplary embodiment may further include a sense resistor R_{S} as shown in FIG. 5.

The sense resistor RS, which is connected between the source electrode of the switching unit 110 and a ground, generates a sense voltage V_{CS}. Since the sense voltage V_{CS} is generated by the drain current I_{DS} flowing in the sense resistor RS, it reflects information of the energy storing unit current I_{IN}.

In this case, since the drain current I_{DS} flows from one end of the sense resistor R_{S} to the other end thereof, the sense voltage V_{CS} in the present exemplary embodiment is a positive voltage as shown in FIG. 6.

Meanwhile, when the drain voltage V_{DS} reaches a zero point of a resonance waveform (a time point at which the resonance waveform is a zero voltage or closes to substantially the zero voltage), the switching controlling unit 130 according to the present exemplary embodiment turns on the switching unit 110.

Meanwhile, the switching controlling unit 130 uses the drain voltage V_{DS} in order to detect the zero point of the resonance waveform.

That is, the switching controlling unit 130 may detect the zero point of the resonance waveform by detecting the drain voltage at a time point from which the resonance starts, that is, the drain voltage V_{DS} in case of the resonance waveform and comparing the detected drain voltage V_{DS} with a voltage corresponding to the zero point of the resonance waveform.

The converter 100 according to the present exemplary embodiment may perform a so-called zero voltage switching in which the switching unit 110 is turned on when the drain voltage V_{DS} of the switching unit 110 reaches the zero point of the resonance waveform as shown in FIG. 7A, by the above-mentioned switching controlling unit 130.

Therefore, according to the present exemplary embodiment, since the hard-switching may be prevented and the soft-switching of the switching element may be performed, problems such as switching loss due to high speed switching, heating of the switching element, and the like may be minimized. Thereby, as a result, according to the present exemplary embodiment, miniaturization and lightness in accordance with a decrease in capacity of the inductor, the capacitor, and the like may also be achieved.

However, in the converter 100 according to the present exemplary embodiment, in the case in which the voltage level of the direct current input power V_{IN} exceeds 50% of the output voltage V_{O}, since the zero point may not be detected in the resonance section of the drain voltage V_{DS} as shown in FIG. 7B, a case in which a boosting operation may be not performed occurs.

Therefore, according to the present exemplary embodiment, it is preferable that the voltage level of the direct current input power V_{IN} is 50% or less of the voltage level of the output voltage V_{O} as shown in FIG. 7A.

Hereinafter, the configuration of the switching controlling unit 130 will be described in more detail with reference to FIG. 5.

The switching unit 130 according to the present exemplary embodiment may include a voltage detecting unit 131, a first comparator 132, and a switching driving unit 133, as shown in FIG. 5.

The voltage detecting unit 131 detects the drain voltage V_{DS} at the time point from which the resonance starts, that is, the drain voltage V_{DS} in case of the resonance waveform.

In this case, the voltage detecting unit may be formed in a form of a voltage distributor configured by a plurality of voltage dividing resistors R1 and R2 connected between the drain electrode of the switching unit 110 and the ground, as shown in FIG. 5. However, the present invention is not limited thereto. For example, the voltage detecting unit 131 may be formed in a form configured by a plurality of capacitors instead of the plurality of voltage dividing resistors. In this case, a leakage current of a boost terminal may be prevented as compared to the form configured by the plurality of voltage dividing resistors.

The first comparator 132 compares the voltage VD that is distributed and detected by the voltage detecting unit 131 with a first reference voltage REF1 corresponding to the zero point of the resonance waveform, so as to output a first signal P1 capable of turning on the switching unit 110 according to a comparison result.

The first comparator 132 includes an inverse input terminal (−) to which the drain voltage Vas detected by the voltage detecting unit 131 is input and a non-inverse input terminal (+) to which the first reference voltage REF1 is input, as shown in FIG. 5.

In this case, if the drain voltage Vas detected by the voltage detecting unit 131 is the first reference voltage REF1 or less, the first comparator 132 outputs the first signal P1 to the switching driving unit 133 in a form as shown in FIG. 1. As a result, the switching driving unit 133 outputs a switching driving signal V_{G} of a high level according to the first signal P1, as shown in FIGS. 5 and 6, so as to turn on the switching unit 110.

Referring to FIG. 2, a converter 10, which is typically used at present, turns on a switching element 1 based on a signal (set pulse, ramp, or the like) that is generated and output from an oscillator 3, or the like that fixes and determines a switching frequency of the switching element 1.

As compared to this, according to the present exemplary embodiment, since the first signal P1 may be generated and output by only a simple circuit configuration such as the comparator, or the like, the soft-switching may be performed without a complex circuit configuration such as the oscillator, or the like. As a result, miniaturization, reduction in a manufacturing cost, and the like may be further preferably achieved.

Meanwhile, the switching unit 130 according to the present exemplary embodiment may further include a second signal outputting unit 134, as shown in FIG. 5.

The second signal outputting unit 134 outputs a second signal P2 capable of turning off the switching unit 110 by using a feedback voltage V_{FDBK} obtained by distributing the output voltage V_{O} by a distribution resistor RD of the outputting unit 140 and the sense voltage V_{CS} generated by the sense resistor R_{S}.

In this case, the feedback voltage V_{FDBK} is detected from a source electrode of a dimming switch 144 of the outputting unit 140 and is input to an input pin FDBK of the switching controlling unit 130, as shown in FIG. 5.

In addition, the sense voltage V_{CS} is detected by the sense resistor R_{S} and is input to an input pin CS of the switching controlling unit 130, as shown in FIG. 5.

The second signal outputting unit 134 may include a second comparator 134-1 and a third comparator 134-2, as shown in FIG. 5.

The second comparator 134-1 compares the feedback voltage V_{FDBK} with a second reference voltage REF2, which is an error reference voltage and amplifies the error, thereby generating and outputting a comparison voltage V_{COMP}, which is an error amplification signal.

In this case, the second comparator 134-1 includes an inverse input terminal (−) to which the feedback voltage V_{FDBK} is input and a non-inverse input terminal (+) to which the second reference voltage REF2 is input, as shown in FIG. 5.

Therefore, the second comparator 134-1 amplifies a voltage obtained by subtracting the feedback voltage V_{FDBK} from the second reference voltage REF2, which is the error reference voltage, so as to generate the comparison voltage V_{COMP}, which is an error amplification voltage.

In addition, the third comparator 134-2 compares the sense voltage V_{CS} reflecting information on the energy storing unit current I_{IN} with the comparison voltage V_{COMP} output from the second comparator 134-1, so as to output a second signal P2 capable of turning off the switching unit 110 according to a comparison result.

In this case, the third comparator 134-3 includes an inverse input terminal (−) to which the comparison voltage V_{COMP} is input and a non-inverse input terminal (+) to which the sense voltage V_{CS} is input, as shown in FIG. 5.

In this case, if the sense voltage V_{CS} is the comparison voltage V_{COMP} or more, the third comparator 134-2 outputs the second signal P2 as shown in FIG. 6 to the switching driving unit 133. As a result, the switching driving unit 133 outputs a switching driving signal V_{G} of a low level in response to the second signal P2, as shown in FIGS. 5 and 6, so as to turn off the switching unit 110.

According to the present exemplary embodiment, the driving of the switching unit 110 may be controlled by a duty adjustment of the first and second signals P1 and P2 described above, such that the output voltage V_{O} may be constantly maintained irrespective of the variation in the load 143 (the LED string in the present exemplary embodiment). As a result, the current flowing in the load 143 may also be constantly maintained.

In addition, the second signal outputting unit 134 according to the present exemplary embodiment may also include a comparison voltage dividing unit 134-3.

In this case, the comparison voltage dividing unit 134-3 is connected between an output terminal of the second comparator 134-1 and the inverse input terminal (−) of the third comparator 134-2, divides the comparison voltage V_{COMP} output from the second comparator 134-1, and outputs the divided comparison voltage to the inverse input terminal (−) of the third comparator, as shown in FIG. 5.

Meanwhile, the switching driving unit 133 according to the present exemplary embodiment may include a third signal outputting unit 133-1 and a switching driving signal outputting unit 133-2, as shown in FIG. 5.

The third signal outputting unit 133-1 generates and outputs a third signal P3 for generating the switching driving signal V_{G}, according to the first signal P1 output from the first comparator 132 and the second signal P2 output from the second signal outputting unit 134, as shown in FIG. 5. Although the present exemplary embodiment describes the case in which the third signal outputting unit 133-1 is implemented as an SR flip-flop, the present invention is not limited thereto.

The third signal outputting unit 133-1 may include a first signal input terminal S (set terminal) to which the first signal P1 is input, a second signal input terminal R (reset terminal) to which the second signal P2 is input, and an output terminal Q from which the third signal P3 is output.

Therefore, the third signal outputting unit 133-1 outputs the third signal P3 that corresponds to the first signal P1 or the second signal P2. For example, the third signal outputting unit 133-1 according to the present exemplary embodiment generates an output of a high level according to the first signal P1 input to the first signal input terminal S and generates an output of low level according to the second signal P2 input to the second signal input terminal R.

In addition, the switching driving signal outputting unit 133-2 outputs the switching driving signal V_{G} for turning on or off the switching unit 110, in response to the third signal P3 output from the third signal outputting unit 133-1.

For example, when the third signal P3 of the high level is input to the switching driving signal outputting unit 133-2 according to the present exemplary embodiment, the switching driving signal outputting unit 133-2 generates the switching driving signal V_{G} of the high level and outputs it to the switching unit 110, and when the third signal P3 of the low level is input thereto, the switching driving signal outputting unit 133-2 generates the switching driving signal V_{G} of the low level and outputs it to the switching unit 110.

Since the switching unit 110 according to the present exemplary embodiment adopts a FET switching element of an n-channel type, the switching unit 110 is turned on when the switching driving signal V_{G} is at the high level, and the switching unit 110 is turned off when the switching driving signal V_{G} is at the low level.

Referring to FIGS. 5 and 6, a switching operation according to the present exemplary embodiment will be described.

In a state in which the direct current input power V_{IN} is applied, when the switching unit 110 is turned on and turned off, and the energy of the energy storing unit 120 is then fully supplied to the load 143 (the LED string in the present exemplary embodiment), the output diode is interrupted.

In this case, due to a resonance between the energy storing unit 120 and the parasitic capacitor of the switching unit 110 or the energy storing unit 120 and the snubber capacitor C_{snubber}, the drain voltage V_{DS} generates the resonance waveform.

In this case, the drain voltage V_{DS} in case of the resonance waveform is detected by the voltage detecting unit 131 and the first signal P1 is output at the zero point the resonance waveform through the comparison between the detected drain voltage Vas and the first reference voltage REF1.

The switching driving signal V_{G} of the high level is output through the switching driving unit 133 according to the above-mentioned first signal P1, and consequently, the switching unit 110 is turned on. Then, during a period in which the switching unit 110 is turned on, the energy storing unit current I_{IN} is increased and the energy storing unit 120 stores the energy.

Meanwhile, the comparison voltage V_{COMP}, which is the error amplification voltage is output by detecting the feedback voltage V_{FDBK} from the source electrode of the dimming switch 144 in a turn on section of the dimming switch 144, comparing the feedback voltage V_{FDBK} with the second reference voltage REF2 (error reference voltage), and amplifying error therebetween.

Thereafter, the sense voltage V_{CS} having the information on the energy storing unit current I_{IN} reflected thereto is detected by the sense resistor R_{S} and the second signal P2 is output by comparing the sense voltage R_{S} with the comparison voltage V_{COMP}.

The switching driving signal V_{G} of the low level is output through the switching driving unit 133 according to the above-mentioned second signal P2, and consequently, the switching unit 110 is turned off.

Once the switching unit 110 is turned off and the output diode D is conducted, the energy storing unit current I_{IN} flows into a load 143 and consequently, the output capacitor C is charged. Thereafter, once the energy of the energy storing unit 120 is fully supplied to the load 143, the drain voltage Vas is again resonated. In this case, the switching operation is performed while repeating the above-mentioned operation.

As a result, according to the present exemplary embodiment, the duty of the switching driving signal V_{G} may be controlled by the duty adjustment of the first and second signals P1 and P2, and consequently, the switching operation of the switching unit 110 may be controlled. Therefore, the output voltage V_{O} may be constantly maintained according to the above-mentioned switching control irrespective of the variation in the load, and consequently, the current flowing in the load 143 is also constantly maintained.

In addition, according to the present exemplary embodiment, the switching unit 110 may be turned on according to the first signal P1 reflecting the information on the zero point of the drain voltage V_{DS} in the resonance section. In this case, the drain current I_{DS} flows in the switching unit 110, the zero voltage switching may be performed. Therefore, since the hard-switching may be prevented and the soft-switching of the switching element may be performed, problems such as switching loss due to high speed switching, heating of the switching element, and the like may be minimized.

Further, according to the present exemplary embodiment, since the first signal P1 may be generated and output by only a simple circuit configuration such as the comparator, or the like, the soft-switching may be performed without a complex circuit configuration such as an oscillator, or the like.

Functions of various components shown in the drawings of the present invention may be associated with suitable software and may be provided by a use of dedicated hardware as well as hardware capable of executing software. When the functions are provided by the processors, the above-mentioned functions may be provided by a single dedicated processor, a single shared processor, or a plurality of individual processors in which some of them may be shared.

In addition, an explicit use of the terms “controlling unit” is not to be construed as being exclusively referred to as hardware capable of executing software, and the controlling unit may implicitly include, without limit, a micro processor (MCU), a digital signal processor (DSP) hardware, and a read only memory (ROM), a random access memory (RAM), and a non-volatile storage device for storing software.

In the claims of the present specification, components represented as means for performing specific function are intended to include any way performing the specific function, and the components may include any form of software including a combination of circuit components performing the specific function, or firmware, microcode, or the like coupled to appropriate circuits in order to perform software for performing the specific function.

In the present specification, ‘an exemplary embodiment’ of the present invention and other modified expressions mean that a certain feature, structure, or characteristic is included in at least one exemplary embodiment of the present invention.

Accordingly, the expression “an exemplary embodiment” and other modified examples in the present specification may not necessarily denote the same exemplary embodiment.

In the present specification, in the case in which it is described that a method includes a series of steps, a sequence of these steps suggested herein is not necessarily a sequence in which these steps may be executed. That is, any described step may be omitted and/or any other step that is not described herein may be added to the method.

In the present specification a term “connected” used herein is defined as being directly or indirectly connected in an electrical or non-electrical scheme.

In addition, targets described as being “adjacent to” each other may physically contact each other, be close to each other, or be in the same general range or region, in the context in which the above phrase is used.

In addition, terms used in the present specification are for explaining the embodiments rather than limiting the present invention. Unless explicitly described to the contrary, a singular form includes a plural form in the present specification. In addition, components, steps, operations, and/or elements mentioned by ‘comprise’ or ‘comprising’ used in the present specification mean the existence or addition of one or more other components, steps, operations, elements and apparatus.

According to the exemplary embodiment of the present invention, the problems such as the switching loss, the heating of the switching element, and the like due to the high speed switching may be minimized.

In addition, according to the exemplary embodiment of the present invention, miniaturization and lightness in accordance with a decrease in capacity of the inductor, the capacitor, and the like may be achieved.

In addition, according to the exemplary embodiment of the present invention, miniaturization and reduction in a manufacturing cost may be achieved.

However, the scope of the present invention is not limited to the above-mentioned effects.

Hereinabove, the present invention has been described with reference to exemplary embodiments thereof. All exemplary embodiment and conditional illustrations in the present specification have been described to intend to assist in understanding of a principle and concept of the present invention by those of ordinary sill in the art. Therefore, it will be understood by those of ordinary skill in the art that various changes in form and details may be made therein without departing from the spirit and scope of the inventive concept as defined by the appended claims. Therefore, the exemplary embodiments disclosed herein should be considered in an illustrative aspect rather than a restrictive aspect. The scope of the present invention should be defined by the following claims rather than the above-mentioned description, and all technical spirits equivalent to the following claims should be interpreted as being included in the present invention.

What is claimed is:

1. A converter comprising:
a switching unit;
an energy storing unit storing energy from direct current input power and then generating an output voltage according to a switching operation of the switching unit; and
a switching controlling unit turning on the switching unit when a voltage between one end of the switching unit and the other end thereof reaches a zero point of a resonance waveform,
wherein the switching controlling unit includes:
a voltage detecting unit detecting the voltage one end of the switching unit and the other end thereof in case of a resonance waveform;
a first comparator comparing the voltage detected by the voltage detecting unit with a predetermined first reference voltage corresponding to the zero point of the resonance waveform and outputting a first signal according to a comparison result; and
a switching driving unit turning on the switching unit in response to the first signal.

2. The converter according to claim 1, wherein the direct current input power has a voltage level that is 50% or less of a voltage level of the output voltage.

3. The converter according to claim 1, further comprising a sense resistor connected between the other end of the switching unit and a ground.

4. The converter according to claim 3, wherein the switching controlling unit further includes a second signal outputting unit outputting a second signal by using a feedback voltage corresponding to the output voltage and a sense voltage generated by the sense resistor.

5. The converter according to claim 4, wherein the switching driving unit turns off the switching unit in response to the second signal.

6. The converter according to claim 4, wherein the switching driving unit includes:
a third signal outputting unit outputting a third signal according to the first and second signals; and
a switching driving signal outputting unit outputting a switching driving signal according to the third signal so as to turn on and off the switching unit.

7. The converter according to claim 4, wherein the second signal outputting unit includes:
a second comparator comparing the feedback voltage with a second reference voltage and outputting a comparison voltage according to a comparison result; and
a third comparator comparing the sense voltage with the comparison voltage and outputting the second signal according to a comparison result.

8. The converter according to claim 7, wherein the second signal outputting unit further includes a comparison voltage dividing unit connected between an output terminal of the second comparator and an input terminal of the third comparator and dividing the comparison voltage output from the second comparator so as to output to the input terminal of the third comparator.

9. The converter according to claim 1, wherein the voltage detecting unit is formed by a plurality of voltage dividing resistors connected between one end of the switching unit and a ground.

10. The converter according to claim 1, wherein the voltage detecting unit is formed by a plurality of capacitors connected between one end of the switching unit and a ground.

11. The converter according to claim 1, wherein the first comparator includes an inverse input terminal and a non-inverse input terminal, and
the inverse input terminal is input with the voltage detected by the voltage detecting unit and the non-inverse input terminal is input with the first reference voltage.

12. The converter according to claim 7, wherein the second comparator includes an inverse input terminal and a non-inverse input terminal, and
the inverse input terminal is input with the feedback voltage and the non-inverse input terminal is input with the second reference voltage.

13. The converter according to claim 7, wherein the third comparator includes an inverse input terminal and a non-inverse input terminal, and
the inverse input terminal is input with the comparison voltage and the non-inverse input terminal is input with the sense voltage.

14. The converter according to claim 1, wherein the switching unit has a snubber capacitor connected in parallel thereto.

15. A switching controlling circuit controlling a switching operation of a switching element controlling a generation of an output voltage from direct current input power by an energy storage element, the switching controlling circuit turning on the switching element when a voltage between one end of the switching element and the other end thereof reaches a zero point of a resonance waveform, comprising:
a voltage detecting unit detecting a voltage between one end of the switching element and the other end thereof in case of a resonance waveform;
a first comparator comparing the voltage detected by the voltage detecting unit with a predetermined first reference voltage corresponding to the zero point of the resonance waveform and outputting a first signal according to a comparison result; and
a switching driving unit turning on the switching element in response to the first signal.

16. The switching controlling circuit according to claim 15, wherein the direct current input power has a voltage level that is 50% or less of a voltage level of the output voltage.

17. The switching controlling circuit according to claim 15, further comprising a second signal outputting unit outputting a second signal by using a feedback voltage corresponding to the output voltage and a sense voltage generated by a sense resistor,
wherein the sense resistor is connected between the other end of the switching element and a ground.

18. The switching controlling circuit according to claim 17, wherein the switching driving unit turns off the switching element in response to the second signal.

19. The switching controlling circuit according to claim 17, wherein the switching driving unit includes:
a third signal outputting unit outputting a third signal according to the first and second signals; and
a switching driving signal outputting unit outputting a switching driving signal according to the third signal so as to turn on and off the switching element.

20. The switching controlling circuit according to claim 17, wherein the second signal outputting unit includes:
a second comparator comparing the feedback voltage with a second reference voltage and outputting a comparison voltage according to a comparison result; and
a third comparator comparing the sense voltage with the comparison voltage and outputting the second signal according to a comparison result.

21. The switching controlling circuit according to claim 20, wherein the second signal outputting unit further includes a comparison voltage dividing unit connected between an output terminal of the second comparator and an input terminal of the third comparator and dividing the comparison voltage output from the second comparator so as to output to the input terminal of the third comparator.

22. The switching controlling circuit according to claim 15, wherein the voltage detecting unit is formed by a plurality of voltage dividing resistors connected between one end of the switching element and a ground.

23. The switching controlling circuit according to claim 15, wherein the voltage detecting unit is formed by a plurality of capacitors connected between one end of the switching element and a ground.

24. The switching controlling circuit according to claim 15, wherein the first comparator includes an inverse input terminal and a non-inverse input terminal, and
the inverse input terminal is input with the voltage detected by the voltage detecting unit and the non-inverse input terminal is input with the first reference voltage.

25. The switching controlling circuit according to claim 20, wherein the second comparator includes an inverse input terminal and a non-inverse input terminal, and
the inverse input terminal is input with the feedback voltage and the non-inverse input terminal is input with the second reference voltage.

26. The switching controlling circuit according to claim 20, wherein the third comparator includes an inverse input terminal and a non-inverse input terminal, and
the inverse input terminal is input with the comparison voltage and the non-inverse input terminal is input with the sense voltage.

27. The switching controlling circuit according to claim 15, wherein the switching element has a snubber capacitor connected in parallel thereto.

28. A switching controlling method of controlling a switching operation of a switching element controlling a generation of an output voltage from direct current input power by an energy storage element and turning on the switching element when a voltage between one end of the switching element and the other end thereof reaches a zero point of a resonance waveform,
detecting a voltage between one end of the switching element and the other end thereof in case of the resonance waveform;
comparing the detected voltage between one end of the switching element and the other end thereof with a predetermined first reference voltage corresponding to the zero point of the resonance waveform and outputting a first signal according to a comparison result; and
turning on the switching element in response to the first signal.

29. The switching controlling method according to claim 28, further comprising:
detecting a feedback voltage corresponding to the output voltage;
detecting a sense voltage;
outputting a second signal by using the detected feedback voltage and the sense voltage; and
turning off the switching element in response to the second signal,
wherein the sense voltage is generated by a sense resistor connected between the other end of the switching element and a ground

30. The switching controlling method according to claim 29, wherein the outputting of the second signal includes:
comparing the feedback voltage with a second reference voltage and outputting a comparison voltage according to a comparison result; and
comparing the sense voltage with the comparison voltage and outputting the second signal according to a comparison result.
